(19) United States
(12) Patent Application Publication
(10) Pub. No.: US 2005/0251794 A1
(43) Pub. Date: Nov. 10, 2005

(54) Method of debugging code and software debugging tool

(76) Inventors: Jason A. Taylor, Melbourne, FL (US); John R. Wagner, Melbourne, FL (US); Matthew A. Taylor, Melbourne, FL (US)

Correspondence Address: IP STRATEGIES, 12 1/2 WALL STREET, SUITE I, ASHEVILLE, NC, 28801, US

(21) Appl. No.: 11/098,025

(22) Filed: Mar. 30, 2005

Related U.S. Application Data
(60) Provisional application No. 60/563,240, filed on Apr. 16, 2004.

(51) Int. Cl. G06F 9/45

(52) U.S. Cl. 717/148; 717/125

(57) ABSTRACT

A process of debugging application code includes stopping execution of the application, stepping backward through the code by line or instruction, stopping at a bug point in the code, modifying the state of the application at the bug point, and resuming execution of the application. A memory medium stores instructions executable by a processor to perform the process, or stores instructions executable by a processor to provide an interface that allows a user to perform the process. A system includes a processor that executes instructions to perform the process, or includes a processor that executes instructions to provide an interface that allows a user to perform the process.

### CROSS-REFERENCE TO RELATED APPLICATION

This is related to and claims priority from U.S. Provisional Patent Application No. 60/563,240, which was filed on Apr. 16, 2004.

### BACKGROUND OF THE INVENTION

When debugging software, it would be helpful to step backward through the code to find the root cause of a bug. The ability to step backward in code has been possible using standard debugging techniques, but conventional schemes for doing so are not practical. Using conventional techniques, a debugger single-steps through every instruction the application executes to record a log of exactly what has changed in the application's state on a per-instruction basis. Unfortunately, the performance implications of this scheme make it impractical. A single step in a traditional debugger requires two context switches and an exception, which is extremely slow relative to the actual execution of the instruction.

Further, conventional step-backward debugging for compiled code causes the instruction pointer to be moved backward, but the rest of the process state, such as the heap memory, stack memory, and processor registers, are not affected. Reverse debugging in more advanced forms does exist for interpreted languages, such as java and lisp, but it is much easier in these environments, because the debugging takes place inside a virtual machine.

### SUMMARY OF THE INVENTION

The present invention provides an easy-to-use and highly discoverable interface that allows a developer to step backward through code in a conventional debugger. The process of the invention allows a software developer to step backward, line-by-line, out of the current function, to the last breakpoint, to a specific line, or to the point where a memory location or variable was modified, and provides the ability to back-step past common kernel calls and exceptions.

According to the present invention, a user can step back to the point where a specific value was placed in a specific memory location. Debugging of heap overruns, stack overruns, race conditions, and deadlocks is simplified. Also, a user can save the execution history to disk along with a crash dump, preferably to an extent that the complete process state over time can be recorded during application usage, so that this information can later be processed by the present invention as integrated with a standard IDE, allowing full backward and forwards debugging session to be executed. According to the invention, a user can perform exploratory testing and rollback from crashes, drop bookmarks to be to indicate major decision points/paths through the testing process, and generate a decision graph/report that shows the steps through an application. When the debugging tool is enabled, an application will run at a reasonable percentage, for example, 25%, of its normal operating speed.

The debugging tool preferably is integrated with a conventional debugger. The process implemented by the tool allows a user to step backward through the code at any time, such as to go backward by a single instruction or line of code, or go back to the last breakpoint or to the point that the current function was called. The user can modify the state of the application after stepping backward, and resume execution with the new state. The process undoes all aspects of the instructions being undone, including both register and memory changes, undoing both stack and heap memory. The process undoes common actions performed by the kernel, such as memory allocation, file management, and registry access.

Using the process, a user can step back out of race conditions and deadlocks, and investigate their cause, and can step back to the line of code that last modified any given variable or memory location, with modes for finding the cause of heap and stack overruns. The process also allows for stepping back to the point where a specific value is written to the variable or memory location (a specific loop index, for example). As an optional feature, the process can include the action of saving the execution history to a file along with a crash dump, allowing the user to later open the file into the conventional debugger and still be able to step backward through the code. Thus, the debugging tool can act as a “black box” that records the exact sequence of events leading to a failure, with the ability to replay this sequence whenever it is needed. The debugging tool can also include a non-debugger interface that allows users to step machine-state-backward during testing without requiring use of a debugger.

According to an aspect of the invention, a process of intercepting and performing custom actions for code instructions at runtime includes executing the instructions from a start point to a point of interest and recording changes made by every instruction at runtime. The recorded changes are undone in reverse order from the point of interest toward the start point. At a change point, a change is made to an instruction. The change point is usually an intermediate point between the point of interest and the start point, but can also be the start point itself. An effect at the point of interest caused by the change made at the change point is determined, and execution of the instructions resumes.

The point of interest, for example, can be a point at which an error occurs. In this case, the change point instruction can be an instruction that is suspected of causing the error. If so, determining an effect at the point of interest caused by the change made at the change point can include executing the instructions from the changed instruction at the change point to the point of interest. It can then be determined whether the change made at the change point fixed the error, after resuming execution of the instructions to the point of interest.

The code can include instrumentation that causes the recording of changes made by every instruction at runtime. The recording of changes made by every instruction at runtime can include recording the changes to a log. In this case, when the log is full, the oldest recorded log entries can be deleted to make room for a newly-recorded entry. Recording changes made by every instruction at runtime can also include saving an execution history to disk with a crash dump file. In this case, the process can also include opening the crash dump file to access the execution history.

Making the change to the instruction at the change point can include mapping the instruction to the code, and changing the code.

The process can also include anticipating kernel calls while executing the instructions. In this case, the process can also include determining the state effect of a kernel call, and recording changes made by every instruction at runtime can include recording the changes resulting from the state effect. If this action is performed, undoing the recorded changes can include reallocating memory and putting the changes recorded from the state effect back into memory space. In this case, the process can also include redirecting kernel calls from old handle values to new handle values.

The process can be performed in a multi-processor system, in which case undoing the recorded changes in reverse order in one thread automatically causes recorded changes to be undone in reverse order in all threads.

The change point can be an instruction that modifies a memory location. In this case, the instruction can be the next instruction that modifies a memory location, in reverse sequence from the point of interest. For example, the point of interest can include a heap corruption error and/or a stack corruption error.

According to another aspect of the invention, a memory medium can store instructions executable by a processor to perform the process as described above. In addition, a memory medium can store instructions executable by a processor to provide a user interface that allows a user to perform the process as described above. A memory medium can also store instructions executable by a processor to integrate the process described above with a separate debugging process. In this case, the instructions can also be executed by a processor to modify a user interface of the debugging process to allow a user to perform the process.

According to another aspect of the invention, a system includes a processor that executes instructions to perform the process as described above. A system can also include a processor that executes instructions to provide an interface that allows a user to perform the process described above. In addition, a system can include a processor that integrates the process with a separate debugging process. In this case, the processor can also modify a user interface of the debugging process to allow a user to perform the process.

According to another aspect of the invention, a process of debugging application code includes stopping execution of the application, stepping backward through the code by line or instruction, stopping at a bug point in the code, modifying the state of the application at the bug point, and resuming execution of the application. For example, modifying the state of the application at the bug point can include undoing register changes, or undoing memory changes, which can include undoing heap- and stack-based memory changes. In addition, at the bug point, the process can also modify the state of the application going forward. For example, modifying the state of the application at the bug point can include modifying a memory location to contain a corrected value and resuming the application to observe the effects, such as by replacing at least some memory content with the corrected value.

The execution history can also be saved. For example, the complete process state can be recorded over time during application usage, or the execution history can be saved with a crash dump.

Changes can also be recorded while instructions are executed. Stepping backward through the code can include executing backward by undoing execution results, data can be streamed to external memory.

Modifying the state of the application at the bug point can include launching a debugging program.

According to another aspect of the invention, a memory medium stores instructions executable by a processor to perform the process described above.

According to another aspect of the invention, a memory medium stores instructions executable by a processor to provide an interface that allows a user to perform the process described above.

According to another aspect of the invention, a system includes a processor that executes instructions to perform the process described above.

According to another aspect of the invention, a system includes a processor that executes instructions to provide an interface that allows a user to perform the process described above.

### BRIEF DESCRIPTION OF THE DRAWINGS

FIG. 1 is a flow diagram of an exemplary aspect of the process of the invention.

FIG. 2 is a flow diagram of another exemplary aspect of the process of the invention.

FIG. 3 is a block diagram of an exemplary system of the invention.

FIG. 4 is an illustration of an exemplary storage medium of the invention.

FIG. 5 is an illustration of an exemplary debugger menu according to the invention.

FIG. 6 is an illustration of an exemplary context menu according to the invention.

FIG. 7 is an illustration of an exemplary debug error display according to the invention.

### DETAILED DESCRIPTION OF THE INVENTION

Process

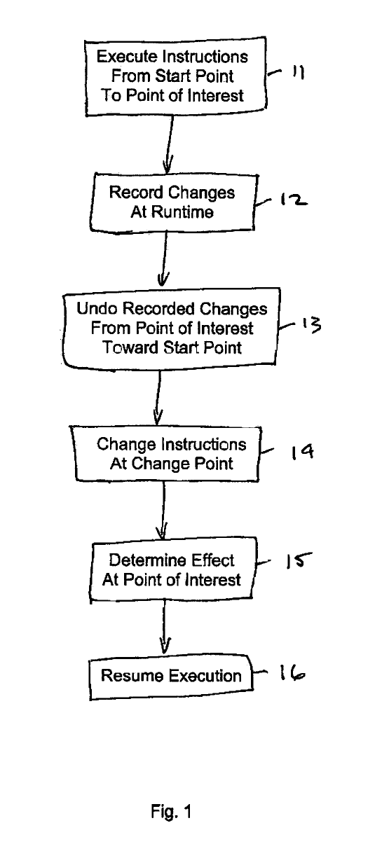

Generally, as shown in FIG. 1, the process of the invention is performed as instructions are executed 11 from a start point to a point of interest. Changes made by every instruction at runtime are recorded 12. The recorded changes are undone 13 in reverse order from the point of interest toward the start point. At a change point, a change is made 14 to an instruction. The change point is usually an intermediate point between the point of interest and the start point, but can also be the start point itself. An effect at the point of interest caused by the change made at the change point is determined 15, and execution of the instructions resumes 16.

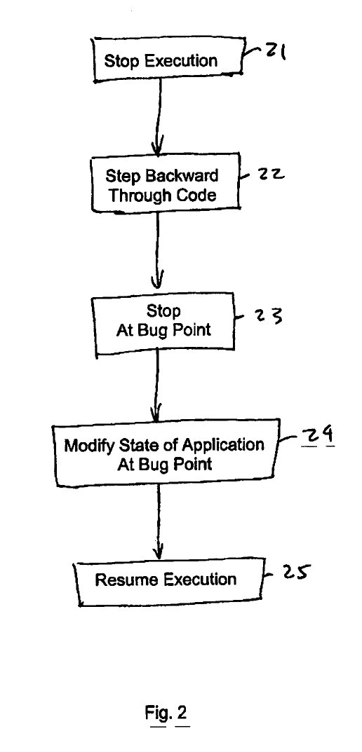

As shown in FIG. 2, the general process of the invention can be performed advantageously as a process of debugging application code. This process includes stopping execution 21 of the application, stepping backward 22 through the code by line or instruction, stopping 23 at a bug point in the code, modifying 24 the state of the application at the bug point, and resuming execution 25 of the application. For example, modifying the state of the application at the bug point can include undoing register changes, or undoing memory changes, which can include undoing heap- and stack-based memory changes.

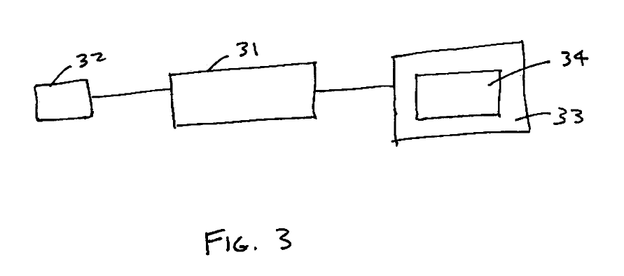

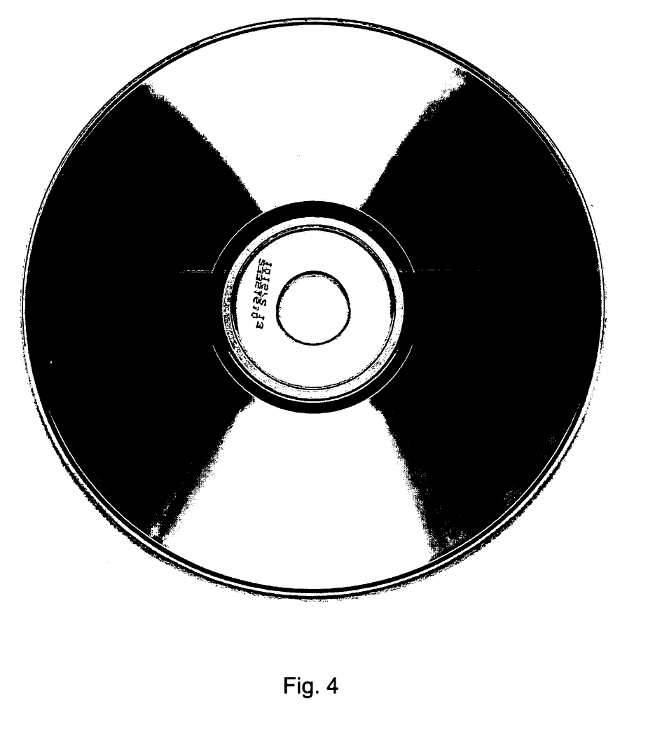

The system of the invention can be configured to include a processor 31 that is adapted to perform the process of the invention, as shown in FIG. 3. This exemplary system can include input/output capability 32 for a user, and a user interface 34 presented on a monitor 33 or other visual display. Any suitable alternative configuration can be used to perform the process of the invention. Instructions for causing a processor to perform the process of the invention can be stored on an appropriate memory medium, such as the exemplary CD-ROM 41 shown in FIG. 4. Any type of memory medium that is readable by the processor can be used to store the instruction.

Thus, the process of the present invention includes intercepting and performing custom actions for any instruction in a process, at runtime. This capability is used to record the changes made by each and every instruction executed (in user mode) in the process being debugged. Practically, there is a limit to the number of instructions that can be logged, namely, a user-configurable log size. The oldest data can be discarded when the log is full. That is, every machine instruction is recorded and can be mapped back to lines of developer-written code. Since the changes made by each instruction are known, executing backward can be implemented as the act of undoing the actions recorded in the change log. For actions performed in user mode, this is guaranteed to produce an exact representation of any previous state, as all changes were recorded.

The size of this execution log is user-configurable, such that the oldest data is discarded if the log is full. A typical development machine should be able to store tens of millions of past instructions in a large log. If the user needs a history that is too large to store in local memory, it is possible to stream older data to disk instead of discarding it.

The entire execution history can also be saved to disk with a crash dump file. When the user later opens this crash dump file, the saved execution history can be accessed to allow the user to perform all of the features described while debugging a crash dump. This feature is especially useful with respect to a dump file created by a customer in his own environment for later debugging.

The process of the present invention is most advantageous when used in user-mode. For code paths that involve only user-mode code, the scheme described previously will work without issue. That is, kernel calls can and will change the state of the application in a way that can't be undone by reversing only the user-mode actions. However, it can be determined in advance when the application is going to make a kernel call, which call is being made, and what the parameters are to the kernel call. To allow undoing of common kernel actions, this information is used to determine what in the application's state will be affected by the kernel call, and to record any changes that are made. For example, if the application tries to free memory, for example by using NtFreeVirtualMemory, the contents of the memory being freed will be saved along with the location of the block of memory. When a request is made to undo this call, the memory is reallocated and the saved contents are placed back into the memory space. To the application, it is as if the memory was never de-allocated. In the case of handle values, which might change after reopening, kernel calls that use the old handle value are redirected to the new handle, but this can be handled on the user-mode side by tracking calls into the kernel.

According to the present invention, it is not possible to completely reverse any calls that modify the state of an external process or machine. For example, the sending of a packet onto the network cannot be taken back. It will be possible to step backward past calls that change external processes or machines, but re-executing the code at this point may not have the desired effect, as not all actions will be undone. If an attempt is made to step backward past an action that cannot be undone, the user will be presented with three options:
1. Rewind up to the action that cannot be undone, but not past it.
2. For pipes, sockets, and LPC/RPC handles, rewind to the point where the object was created. The user will then be able to modify the state and reestablish the connection. Note that the original problem might not repro after a reconnection, as the second request might result in a different reply, but it will give the user a chance to step through the code.
3. Rewind to the point originally requested, even though some actions can't be undone. As the state of variables and memory in the process being debugged will still be fully correct, this can be useful for investigating the cause of bugs. If this option is chosen, the process state can no longer be modified and resumed, as the external connection is no longer valid.

Because the process of the present invention has control of all threads in the process, it can also record the exact order of instruction execution on all the processors in the system (this ordering is global to the entire process, so it will capture the correct order even on a multiprocessor system). This is valuable when a race condition or deadlock has occurred in the application, since these typically depend on the order of execution in different threads. Stepping backward in one thread will automatically step backward any other threads that executed in that timeframe, meaning that the state of every thread in the application will be consistent with what actually happened during execution. Also, if the user has not modified the application's state, a normal single step performed after stepping backward will, instead of executing directly, look up the state in the same execution history as the backward step. This allows investigation of race conditions without getting different results after single stepping. A developer using this tool can easily visualize the sequence of events leading to a race condition.

Heap and stack corruption bugs are other types of problems that can be corrected by stepping backward in the code. Because the process of the invention logs all modifications made by the application to memory, it is possible to search for the last time a given memory location was modified. This allows a developer to select the area of memory that was corrupted and automatically step back to the exact point in the code to which it was last written. If the most recent write action was not the cause of the bug, the feature can be used again to search further back into the execution history, limited only by the size of the log.

User Interface

The tool of the present invention includes a user interface design that makes it simple for a user to implement the process of the invention. The concepts of the tool and process of the present invention apply to all classes and types of standard debuggers with which the tool will be integrated. For ease of explanation, the user interface is described below with reference to the Microsoft® Visual Studio .NET debugging interface, which is not limiting on the scope of the invention as contemplated by the inventors.

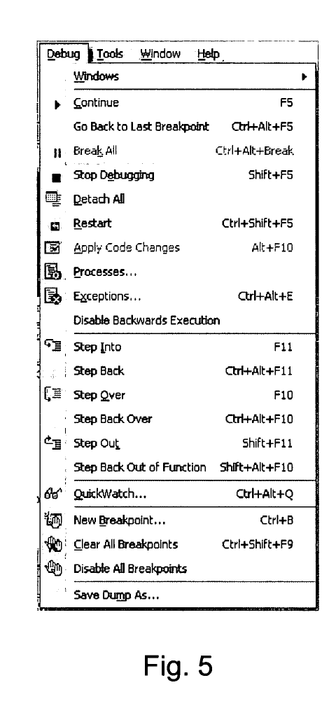

When the user starts the debugger, the debug menu will include three new commands, which in this example are named “Go Back to Last Breakpoint”, “Step Back”, and “Step Back Out of Function”. An exemplary menu is shown in FIG. 5.

Selecting “Step Back” causes a step backward one line in the source view, or one instruction in the disassembly view. Selecting “Step Back Out of Function” takes the user to the point where the current function was called. Selecting “Go Back to Last Breakpoint” causes backward movement until a breakpoint is hit. Menus provided for other standard debuggers will have similar functions available.

Because the logging of past application behavior has a performance impact, a “Disable Backward Execution” option can also be available to the user. This command will disable the backward execution feature and allow the application to continue at full speed. When disabled, this menu item becomes “Enable Backward Execution” to provide complementary action.

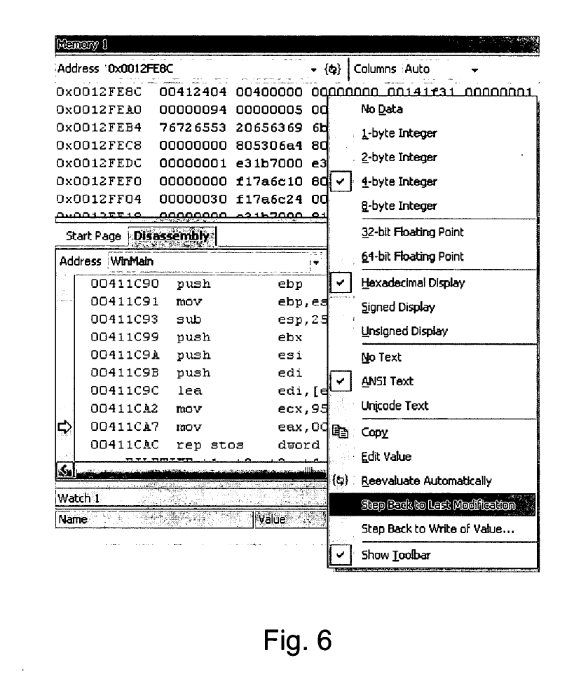

To expose the “step back to the line of code that last modified any given variable or memory location” feature, new menu items are added to the context menus, for example, when a user right-clicks on a variable or a location in the memory window. There then are two items, one searching for the last modification to the memory, and the other searching for the point at which a certain value was written to the memory. An example of this context menu is shown in FIG. 6.

Optionally, the user will be given the ability to designate, such as by right-clicking on, a line of source code and select “Go Back to Cursor”, which will function in a complementary fashion to “Run to Cursor”.

Thus, the present invention provides practical step-backward debugging not possible with conventional debuggers by inserting custom instrumentation directly into the application's code stream. By inserting instrumentation code before every instruction, logging the state changes in the application on a per-instruction basis can be performed. This does slow down execution, but typically only by a few cycles per instruction, in contrast to the tens of thousands of cycles of cost with conventional methods. For a typical application, the slowdown will noticeable, but the application will still be usable, even when logging the per-instruction execution history. Utilizing the process of the present invention, stepping backward through code is not something that requires leaving the application running overnight, but rather becomes a practical and useful debugging feature that can be used on an everyday basis.

Exemplary Scenarios

The following are exemplary scenarios in which the debugging method of the invention is used to the advantage of the debugger.

### EXAMPLE 1

User 1 is developing a multithreaded application that can process commands from multiple threads at the same time. He has a race condition in his software that is causing the application to crash with an access violation, but only some of the time. He got a repro under the debugger, and wants to investigate why it is happening. It is crashing during a traversal of a linked list, with the current node pointing at invalid memory. He tried using conventional debugging techniques, but the other threads are all waiting for new commands, and nothing on the crashing thread's call stack helps determine how the pointer was invalid. In order to figure out how the pointer got to be invalid, he uses the “step back” command of the present invention to step backward to the last time the current node was updated, and finds that it was this line of code:
currentNode=currentNode→next;

Somehow, the “next” field of his node structure is not valid. Because this thread was sitting in a read loop, User 1 thinks that another thread might have corrupted it. Because the “step back” command brings all threads back to the state they were in when this line of code was executing, User 1 goes through the running threads in his process and looks at what each of them is doing at this moment in time.

One of the threads is performing a linked list update by deleting a node:
previousNode→next=deletedNode→next;
delete deletedNode;

This thread is sitting at this first instruction, about to execute it. User 1 checks the node pointers and finds that the value of “previousNode” here is exactly the same as “currentNode” in the thread that is crashing. This shouldn't happen because two threads should not be operating on the same linked list at the same time. To determine if this is the problem causing the crash, User 1 switches back to the crashing thread, executes a single step, and records the value of “currentNode”. He switches back to the thread that was deleting a node, and it's still at the same point in the code. However, the new value of “currentNode” he wrote down is the same as “deletedNode” in this thread. User 1 knows now that when this thread continued, it deleted the node the crashing thread was trying to read, and that this is in fact the source of the bug he is trying to fix.

User 1 looks through the source for this particular node deletion function, and notices that it has no synchronization code, explaining why two threads were accessing it at once. He adds the correct synchronization code, and the problem goes away. User 1 is glad that he was able to return the application to this previous state, as it showed him exactly why his application was failing.

### EXAMPLE 2

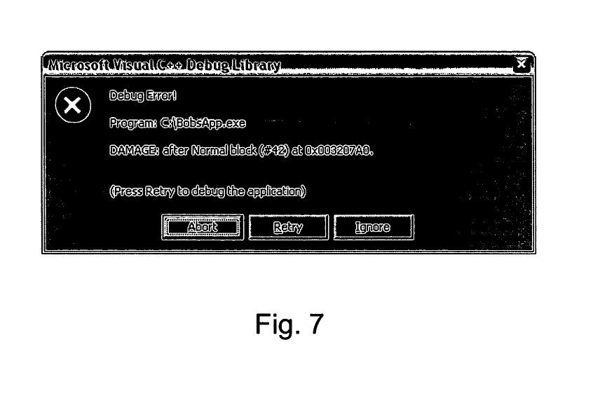

User 2 has a heap corruption bug in the application he is developing, and he needs to get a fix to the customer as soon as possible, as it is blocking them from doing their work. He compiles in debug mode and the Visual C++ runtime gives him the debug error shown in FIG. 7.

User 2 clicks retry to debug and finds that the heap is corrupted when he tries to execute a “delete [ ]” operation in his code. Normally, he would have trouble finding where the actual point of corruption was, but he now has the “step back to the last point where a memory location was modified” command in his conventional debugger, provided by the present invention. He activates this command, points it at the heap block given, and the feature takes him directly back to a “memcpy” call that copied more than the buffer's length. He fixes the bug, and is able to get a fix to the customer the same day.

### EXAMPLE 3

User 3 is working on a component that generates unique identifiers for a session in her company's application. It works most of the time, but occasionally it crashes with an access violation. Since it generates unique identifiers on each run, she can't just restart it under the debugger and single-step through the code, since it's unlikely that it will crash on that specific instance.

Now, however, she has the capability to step backward in the debugger, as provided by the present invention. She writes a small test application that calls her component repeatedly, and starts that under the debugger. After a few minutes, the test application hits the bug and the conventional debugger displays the exception information.

The component is trying to access a null pointer in one of the lookup tables she had generated earlier in the code. To find why this entry was null, User 3 opens the table in the memory view, finds the offending entry, and right-clicks. The context menu in the memory view has a “step back to last modification” option. She clicks this, and the debugger immediately backtracks to the exact point in the code where null was written to this entry. Because it backs up the entire application state as well, she is able to look at the contents of the variables at this moment in the application's execution. It turns out that the application is using a bad value from the previous iteration of the loop, so she uses the “step back” feature to go back to the previous iteration, where this bad value was computed. She finds the cause of the bug, and fixes it.

### EXAMPLE 4

User 4 is a QA staffer doing exploratory testing. He wraps the application he is testing in the “black box” of the present invention so that it is recording every instruction that is run by the application. As he is testing he periodically tells the black box to set a bookmark to which he can return later. He has spent hours walking through his application and all of the sudden, the application crashes for no apparent reason. User 4 presses the rewind button in the black box interface provided by the tool of the present invention, and the application restores itself to the most recent bookmark before the crash. User 4 enlists the aid of a developer and plays the black box forward so that the crash occurs again. The developer pulls up the conventional debugger and gets to work, using the options provided by the Visual Studio debugger to step backward as necessary and easily determine the root cause of the problem.

Preferred embodiments have now been described . . .

1. A process of intercepting and performing custom actions for code instructions at runtime, comprising:
executing the instructions from a start point to a point of interest;
recording changes made by every instruction at runtime;
undoing the recorded changes in reverse order from the point of interest toward the start point;
making a change to an instruction at a change point, wherein the change point is one of the start point and an intermediate point between the point of interest and the start point;
determining an effect at the point of interest caused by the change made at the change point; and
resuming execution of the instructions.

2. The process of claim 1, wherein the point of interest exhibits an error.

3. The process of claim 2, wherein the change point instruction is an instruction that is suspected of causing the error.

4. The process of claim 3, wherein determining an effect at the point of interest caused by the change made at the change point includes executing the instructions from the changed instruction at the change point to the point of interest.

5. The process of claim 4, further comprising determining whether the change made at the change point fixed the error, after resuming execution of the instructions to the point of interest.

6. The process of claim 1, wherein the code includes instrumentation that causes the recording of changes made by every instruction at runtime.

7. The process of claim 1, wherein recording changes made by every instruction at runtime includes recording the changes to a log.

8. The process of claim 7, further comprising, when the log is full, deleting the oldest recorded log entries to make room for a newly-recorded entry.

9. The process of claim 1, wherein recording changes made by every instruction at runtime includes saving an execution history to disk with a crash dump file.

10. The process of claim 9, further comprising opening the crash dump file to access the execution history.

11. The process of claim 1, wherein making the change to the instruction at the change point includes mapping the instruction to the code, and changing the code.

12. The process of claim 1, further comprising anticipating kernel calls while executing the instructions.

13. The process of claim 12, further comprising determining the state effect of a kernel call, wherein recording changes made by every instruction at runtime includes recording the changes resulting from the state effect.

14. The process of claim 13, wherein undoing the recorded changes includes reallocating memory and putting the changes recorded from the state effect back into memory space.

15. The process of claim 14, further comprising redirecting kernel calls from old handle values to new handle values.

16. The process of claim 1, performed in a multi-processor system, wherein undoing the recorded changes in reverse order in one thread automatically causes recorded changes to be undone in reverse order in all threads.

17. The process of claim 1, wherein the change point is an instruction that modifies a memory location.

18. The process of claim 17, wherein the instruction that modifies a memory location is the next instruction that modifies a memory location, in reverse sequence from the point of interest.

19. The process of claim 17, wherein the point of interest includes at least one of a heap corruption error and a stack corruption error.

20. A memory medium, storing instructions executable by a processor to perform the process of claim 1.

21. A memory medium, storing instructions executable by a processor to provide a user interface that allows a user to perform the process of claim 1.

22. A memory medium, storing instructions executable by a processor to integrate the process of claim 1 with a separate debugging process.

23. The memory medium of claim 22, wherein the instructions are further executable by a processor to modify a user interface of the debugging process to allow a user to perform the process.

24. A system, including a processor that executes instructions to perform the process of claim 1.

25. A system, including a processor that executes instructions to provide an interface that allows a user to perform the process of claim 1.

26. A system, including a processor that integrates the process of claim 1 with a separate debugging process.

27. The system of claim 26, wherein the processor further modifies a user interface of the debugging process to allow a user to perform the process.

28. A process of debugging application code, comprising:
stopping execution of the application;
stepping backward through the code by line or instruction;
stopping at a bug point in the code;
modifying the state of the application at the bug point; and
resuming execution of the application.

29. The process of claim 28, wherein modifying the state of the application at the bug point includes undoing register changes.

30. The process of claim 29, wherein modifying the state of the application at the bug point includes undoing memory changes.

31. The process of claim 30, wherein undoing memory changes includes undoing heap- and stack-based memory changes.

32. The process of claim 28, further comprising modifying, at the bug point, the state of the application going forward.

33. The process of claim 32, wherein modifying the state of the application going forward includes modifying the contents of a memory location.

34. The process of claim 33, wherein modifying the contents of the memory location includes replacing contents of the memory location with a corrected value.

35. The process of claim 32, further comprising observing effects of modifying the state of the application going forward when execution is resumed.

36. The process of claim 28, further including saving the execution history.

37. The process of claim 36, wherein saving the execution history includes recording the complete process state over time during application usage.

38. The process of claim 36, wherein the execution history is saved with a crash dump.

39. The process of claim 28, further comprising recording changes while instructions are executed.

40. The process of claim 39, wherein stepping backward through the code includes executing backward by undoing execution results.

41. The process of claim 39, further including streaming data to external memory.

42. The process of claim 28, wherein modifying the state of the application at the bug point includes launching a debugging program.

43. A memory medium, storing instructions executable by a processor to perform the process of claim 28.

44. A memory medium, storing instructions executable by a processor to provide an interface that allows a user to perform the process of claim 28.

45. A system, including a processor that executes instructions to perform the process of claim 28.

46. A system, including a processor that executes instructions to provide an interface that allows a user to perform the process of claim 28.
